(19) United States
(12) Patent Application Publication
(10) Pub. No.: US 2026/0284926 A1
(43) Pub. Date: Sep. 24, 2026

(54) HEMP WOOD PRESERVATIVE COMPOSITIONS AND RELATED METHODS

(71) Applicant: SporoBio, LLC, Hastings, MN (US)

(72) Inventors: Samuel Michael EGGER, Hastings, MN (US); Jeremy Gordon SAUERESSIG, Hastings, MN (US)

(21) Appl. No.: 19/484,663

(22) PCT Filed: May 15, 2024
(86) PCT No.: PCT/US2024/029429

§ 371 Date: Nov. 14, 2025

Related U.S. Application Data
(60) Provisional application No. 63/466,575, filed on May 15, 2023.

(51) Int. Cl. B27K 3/52

(52) U.S. Cl. CPC B27K 3/52

(57) ABSTRACT

Embodiments disclosed herein are hemp wood preservative compositions, and related methods. A composition for treating wood includes a methyl ester composition, hemp seed oil (HSO), wax present in an amount of about 10 wt % or less of the composition, and silica present in an amount of about 10 wt % or less of the composition. A method of forming a composition for treating wood includes forming a mixture including wax and a methyl ester composition, mixing hemp seed oil with the mixture including the wax and the methyl ester composition, and mixing silica with at least one of (1) the mixture including the wax and the methyl ester composition, (2) the hemp seed oil, and/or (3) the hemp seed oil with the mixture including the wax and the methyl ester composition.

### CROSS-REFERENCE TO RELATED APPLICATIONS

This application claims priority to U.S. Provisional Patent Application No. 63/466,575 filed on May 15, 2023, the disclosure of which is incorporated herein, in its entirety, by this reference.

### FIELD

This application relates to compositions and related methods for treating wood.

### BACKGROUND

Wood exposed to the outdoors often requires treatment with a composition to help make the wood resistant to water, pests, and molds.

### SUMMARY

Embodiments disclosed herein are hemp wood preservative compositions, and related methods. In an embodiment, a composition for treating wood includes a methyl ester composition, hemp seed oil (HSO), wax present in an amount of about 10 wt % or less of the composition, and silica present in an amount of about 10 wt % or less of the composition. In an embodiment, a composition for treating wood includes soy methyl ester, hemp seed oil, beeswax, and diatomaceous earth.

In an embodiment, a method of forming a composition for treating wood includes forming a mixture including wax and a methyl ester composition, mixing hemp seed oil with the mixture including the wax and the methyl ester composition, and mixing silica with at least one of (1) the mixture including the wax and the methyl ester composition, (2) the hemp seed oil, and/or (3) the hemp seed oil with the mixture including the wax and the methyl ester composition.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a schematic depicting the interaction between diatomaceous earth, methyl esters, free fatty acids, and beeswax, according to an embodiment.

FIG. 2 is a flow diagram of a method of forming a composition for preserving wood, according to an embodiment.

### DETAILED DESCRIPTION

Embodiments disclosed herein are includes compositions and related methods for treating wood, the compositions including hemp seed oil, methyl esters, beeswax, and diatomaceous earth according to one or more embodiments. The formulations and compositions disclosed herein may be applied to wood to help preserve the wood, such as to make it resistant to the effects of the elements, including water, pests, and molds. The formulations and compositions may also be used in the lubricant industry, such as for food-grade lubricants, and for filtration (e.g., wax-functionalized silicas may be used as filtration aides for removal of hydrocarbons from aqueous media), and chemical remediation. Generally, the combination of methyl esters or similar functional groups in the presence of waxes may be able to easily surface-functionalize a wide range of colloids in unique physical state, such as gels, pseudo solid/liquids, cross-linked compositions, and the like.

### Formulation Components

Reference is made herein to soy methyl esters (ME). However, formulations are not limited to soy methyl esters or what may be its predominant component, fatty acid methyl esters (FAME). Though FAMEs are mono-alkyl esters, given that methanol is predominantly used during the transesterification of triglycerides to FAMEs, other alkyl esters are contemplated in the compositions disclosed herein. For example, fatty acids in general (not limited to fatty acid methyl esters) may be used in one or more embodiments of the compositions described herein.

Hemp seed oil (HSO) may include a wide range of fatty acids (other than FAMEs), such as palmitic and/or other polyunsaturated fats (omega-3, omega-6, and/or linoleic and α-linoleic). About 80% of the fat profile in HSO may be polyunsaturated fats, according to an embodiment. HSO may also include saturated fatty acids, which may be present in smaller quantities than the polyunsaturated fats (e.g., approximately 10% of the fat profile, according to an embodiment). HSO may also include one or more (e.g., all) of antioxidants (Vitamin E), carotene (precursor to Vitamin A), phytosterols, phospholipids, and/or a number of minerals including calcium, magnesium, sulfur, potassium, phosphorus, iron and zinc. HSO may also be rich in chlorophyll.

Cannabidiol (CBD) hemp biomass is a broad label, given how diverse and complex hemp compounds are. In many examples disclosed herein, the primary cannabidiol may include CBD. CBD hemp biomass may also include tetrahydrocannabinol (THC), cannabigerol (CBG), etc., usually at lower amounts than the CBD. Terpenes, such as β-caryophyllene, limonene, etc., may also be included in one or more of the compositions disclosed herein. Isoprenes, the general building block of terpenoid chemistry, may also be included in one or more of the compositions disclosed herein. In some embodiments, hemp biomass may also be represented by flavonoids, a class of anti-oxidants, such as cannflavin A, B, and/or C unique to cannabis. Other flavonoids contributing to this category may be quercetin and/or apigenin, according to an embodiment.

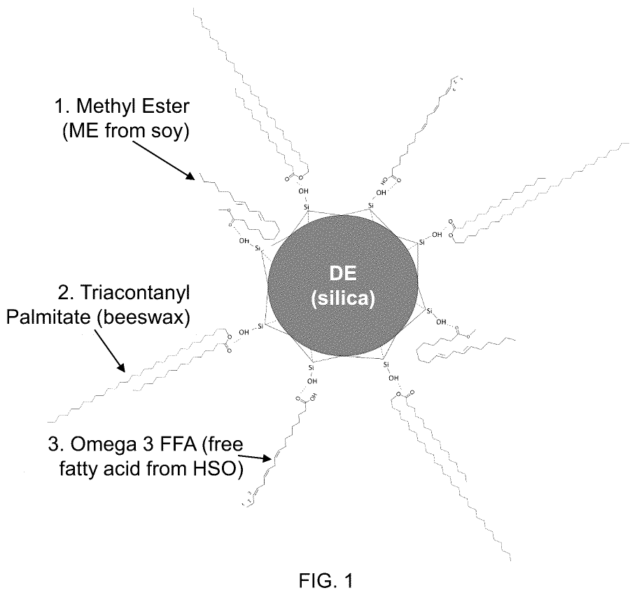

Formulations and composition disclosed herein include one or more waxes, according to an embodiment. Waxes may include natural waxes, such as plant, animal, and modified waxes thereof. The major contributor to beeswax, for example, is triacontanyl palmitate, a wax ester. Waxes may also include petroleum-derived waxes such as paraffin wax, or Montan wax, a saturated fatty acid. Without being limited to any mechanism or mode of action, the wax may bind to silica surfaces, which may be through covalent bond chemistry or basic adsorption, as shown in FIG. 1. The association may be driven by chemical functional groups of the wax, such as esters, alcohols, ketones, aldehydes, and the like, and may be due to silanol chemistry on the surface of diatomaceous earth (DE, e.g., silica). This silanol chemistry may result in covalent bonds or hydrogen bonds with as-described functional groups on waxes.

Formulations disclosed herein include silica, such as from DE. Silica may include natural silicas, such as DE, or synthetic silicas, such as micro, meso, and microporous silica (MCM-41 and SBA-15). These silicas may also be classified in terms of particle size, i.e., micometers to nanometer in diameter. DE may act as a natural and human-safe pesticide. Other components similar to DE/silica in one or more embodiments may include sorbents such as activated carbon, zeolites, and the like.

FIG. 1 is a schematic depicting the potential interaction between diatomaceous earth (e.g., silica); ME, which may be from biodiesel and/or soy; free fatty acids (FFA), which may be from hemp seed oil (HSO); and beeswax (e.g., triacontanyl palmitate). Without being limited to any mechanism or mode of action, the ME and FFA may be associated with the silica surface. Such association may be able to provide a gel-like character to the resulting material, in comparison to naturally harder beeswax. It may be that the silica from the DE is solvated by the ME and FFA, and this solvent may enable the wax, when heated and then cooled, to adsorb or bond to the silica surface.

As provided above, in one or more embodiments, the formulations disclosed herein may be applied to wood to help preserve the wood, such as to make it resistant to the effects of the elements, including water, pests, and molds. The formulations may also be used in the lubricant industry, such as for food-grade lubricants, and for filtration (e.g., wax-functionalized silicas may be used as filtration aides for removal of hydrocarbons from aqueous media), and chemical remediation. Generally, the combination of methyl esters or similar functional groups in the presence of waxes may be able to easily surface-functionalize a wide range of colloids in unique physical state, such as gels, pseudo solid/liquids, cross-linked compositions, and the like.

In an embodiment, a composition for treating wood, includes a methyl ester composition (e.g., soy ME), HSO, wax present in an amount of about 10 wt % or less of the composition, and silica present in an amount of about 10 wt % or less of the composition. In some embodiments, the methyl ester composition may include soy ME, synthetic ME, or combinations thereof. In some embodiment, the methyl ester composition is an entirely natural methyl ester composition (such as the soy ME).

The wax may include one or more of soy wax, beeswax, or hemp wax. In some embodiments, the wax includes beeswax present in an amount of about 2 wt % to about 8 wt % of the composition, such as about 2 wt % to about 5 wt %, about 3 wt % to about 6 wt %, about 4 wt % to about 7 wt %, about 5 wt % to about 8 wt %, about 2 wt % to about 4 wt %, about 3 wt % to about 5 wt % about 4 wt % to about 6 wt %, about 5 wt % to about 7 wt %, about 6 wt % to about 8 wt %, about 2 wt %, about 3 wt %, about 3.75 wt %, about 4 wt % about 5 wt %, about 6 wt %, about 7 wt %, or about 8 wt % of the composition. Embodiments of the composition may include any of these amounts of beeswax in combination with any of the amounts of methyl esther, HSO, silica (e.g., diamtomaceous earth), terpenes, and/or cannabidiol extract described herein.

In some embodiments of the composition, the silica includes diatomaceous earth. The silica (e.g., the diatomaceous earth) may be present in an amount of about 0.5 wt % to about 5 wt % of the composition, such as about 0.5 wt % to about 2 wt %, about 1 wt % to about 2.5 wt %, about 1.5 wt % to about 3 wt %, about 2 wt % to about 3.5 wt %, about 3 wt % to about 4.5 wt %, about 3.5 wt % to about 5 wt %, about 1 wt % to about 2 wt %, about 1.5 wt % to about 2.5 wt %, about 1 wt %, about 1.5 wt %, about 2 wt %, or about 2.5 wt %. Embodiments of the composition may include any of these amounts of silica (e.g., diamtomaceous earth) in combination with any of the amounts of methyl esther, HSO, beeswax, terpenes, and/or cannabidiol extract described herein.

In some embodiments of the composition, the HSO in an amount of about 5 wt % to about 15 wt % of the composition, such as about 5 wt % to about 10 wt %, about 7.5 wt % to about 12.5 wt % about 10 wt % to about 15 wt %; about 5 wt % to about 7 wt %, about 6 wt % to about 8 wt %, about 7 wt % to about 9 wt %, about 8 wt % to about 10 wt %, about 9 wt % to about 11 wt %, about 10 wt % to about 12 wt %, about 11 wt % to about 13 wt %, about 12 wt % to about 14 wt %, about 13 wt % to about 15 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt % of the composition. Embodiments of the composition may include any of these amounts of HSO in combination with any of the amounts of methyl esther, beeswax, silica (e.g., diamtomaceous earth), terpenes, and/or cannabidiol extract described herein.

In some embodiments, the methyl ester composition is present in an amount of about 75 wt % to about 95 wt % of the composition, such as about 75 wt % to about 85 wt %, about 80 wt % to about 90 wt %, about 85 wt % to about 95 wt %, about 75 wt % to about 80 wt %, about 77.5 wt % to about 82.5 wt %, about 80 wt % to about 85 wt %, about 82.5 wt % to about 87.5 wt %, about 85 wt % to about 90 wt %, about 87.5 to about 92.5 wt %, or about 90 wt % to about 95 wt % of the composition. Embodiments of the composition may include any of these amounts of methyl ester in combination with any of the amounts of beeswax, HSO, silica (e.g., diamtomaceous earth), terpenes, and/or cannabidiol extract described herein.

In a particular embodiment, the HSO is present in an amount of about 10 wt % of the composition, the wax comprises beeswax present in an amount of about 3.75 wt % of the composition, and the silica comprises diatomaceous earth present in an amount of about 1.5 wt % of the composition. In another embodiment, the HSO is present in an amount of about 10 wt % of the composition, the wax comprises beeswax present in an amount of about 5 wt % of the composition, and the silica comprises diatomaceous earth present in an amount of about 2.0 wt % of the composition.

In some embodiments, the composition further comprises an extracted cannabidiol present in the composition. For example, the composition may include an extracted cannabidiol present in an amount of 0.1 wt % to about 4 wt %, such as about 0.1 wt % to about 2 wt %, about 1 wt % to about 3 wt %, about 2 wt % to about 4 wt %, about 0.5 wt % to about 1.5 wt %, about 2 wt % to about 3 wt %, about 2.5 wt % to about 3.5 wt %, or about 3 wt % to about 4 wt %. In some embodiments, the composition comprises at least one of CBD, cannabidiolic acid (CBDA), and/or tetrahydrocannabinolic acid (THCA). For example, the composition may include CBD in an amount of about 0.01 wt % to about 0.25 wt % (such as about 0.10 wt %) of the composition and/or CBDA in an amount of about 0.50 wt % to about 1.0 wt % (such as about 0.75 wt %) of the composition. In an embodiment, the composition may include CBD in an amount of about 0.01 wt % to about 0.5 wt % (such as about 0.25 wt %) of the composition and/or CBDA in an amount of about 2.0 wt % to about 3.0 wt % (such as about 2.5 wt % to about 3.0 wt % or about 2.75 wt %) of the composition. In an embodiment, the composition may include CBD present in an amount of about 0.01 wt % to about 0.5 wt % (such as about 0.25 wt %) of the composition, CBDA present in an amount of 2.0 wt % to about 3.0 wt % (such as about 2.25 wt % to about 2.75 wt % or about 2.5 wt %) of the composition, and/or THCA present in an amount of 0.01 wt % to about 0.25 wt % (such as about 0.12 wt %) of the composition.

The composition also may include one or more terpenes present in an amount of about 0.1 wt % to about 1 wt % of the composition, such as about 0.1 wt % to about 0.5 wt %, about 0.25 wt % to about 0.75 wt %, about 0.5 wt % to about 1.0 wt %, about 0.1 wt % to about 0.3 wt %, about 0.2 wt % to about 0.4 wt %, about 0.3 wt % to about 0.5 wt %, about 0.4 wt % to about 0.6 wt %, about 0.5 wt % to about 0.7 wt %, about 0.6 wt % to about 0.8 wt %, about 0.7 wt % to about 0.9 wt %, about 0.8 wt % to about 1.0 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1.0 wt %.

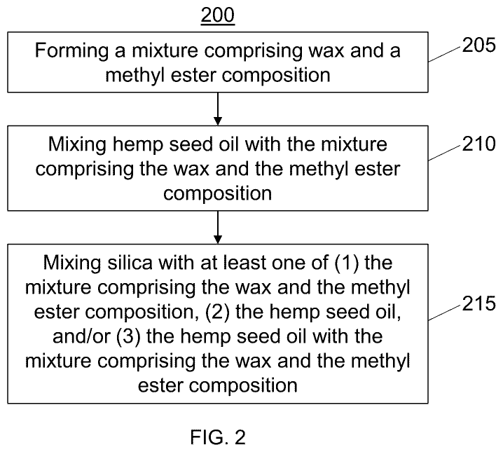

FIG. 2 is a flow diagram of a method 200 of forming a composition for preserving wood, according to an embodiment. The method includes an act 205 of forming a mixture comprising wax and a methyl ester composition, an act 210 of mixing hemp seed oil with the mixture comprising the wax and the methyl ester composition, and an act 215 of mixing silica with at least one of (1) the mixture comprising the wax and the methyl ester composition, (2) the hemp seed oil, and/or (3) the hemp seed oil with the mixture comprising the wax and the methyl ester composition. Acts 205, 210, and 215 of the method 200 are for illustrative purposes. For example, the acts 205, 210, and 215 of the method 200 may be performed in different orders, split into multiple acts, modified, supplemented, or combined.

In some embodiments of the method 200, the wax comprises beeswax and forming the mixture comprising the beeswax and the methyl ester composition includes heating the mixture comprising the beeswax and the methyl ester composition to a temperature of about 45° C. to about 55° C. to dissolve the beeswax in the methyl ester composition. The beeswax may be present in any of the amounts of the composition described above, such as but not limited to an amount of about 3 wt % to about 7 wt % of the composition.

In some embodiments of the method 200, the silica comprises diatomaceous earth. The silica (e.g., the diatomaceous earth) may be present in any of the amounts of the composition described above, such as but not limited to an amount of about 1 wt % to about 3 wt % of the composition.

In some embodiments of the method 200, the HSO is present in any of the amounts of the composition described above, such as but not limited to an amount of about 5 wt % to about 15 wt % of the composition.

In some embodiments of the method 200, the methyl ester composition is present in any of the amounts of the composition described above, such as an amount of about 75 wt % to about 90 wt % of the composition.

In an embodiment of the method 200, the HSO is present in an amount of about 10 wt % of the composition, the wax comprises beeswax present in an amount of about 3.75 wt % of the composition, and the silica comprises diatomaceous earth present in an amount of about 1.5 wt % of the composition.

In an embodiment of the method 200, the HSO is present in an amount of about 10 wt % of the composition, the wax comprises beeswax present in an amount of about 5 wt % of the composition, and the silica comprises diatomaceous earth present in an amount of about 2.0 wt % of the composition.

In some embodiments, the method 200 further comprises mixing one or more terpenes in any of the amounts described above into at least one of (1) the mixture comprising the wax and the methyl ester composition, (2) the hemp seed oil, and/or (3) the hemp seed oil and mixed with the mixture comprising the wax and the methyl ester composition.

In some embodiments, the method 200 further comprises extracting cannabidiol from a cannabidiol hemp biomass with at least a portion of the methyl ester composition before forming the mixture comprising the methyl ester composition and the wax such that the methyl ester composition includes a cannabidiol extract. Extracting the cannabidiol from the cannabidiol hemp biomass with at least the portion of the methyl ester composition may include extracting the cannabidiol from the cannabidiol hemp biomass with at least the portion of the methyl ester composition in multiple iterations.

### Example Formulation Preparations

Formulations (e.g., compositions) were made from combinations of soy MEs, hemp seed oil HSO, extracted cannabidiol (extracted using ME over one or more iterations (e.g., one, two, or three iterations), DE, and one or more waxes (e.g., beeswax, soy wax, and/or hemp wax).

The formulations disclosed herein may be broken down into three major categories: 1) mixtures of ME and HSO with varying weight percent (5 wt %, 10 wt %, or 15 wt %) of HSO; 2) extraction of CBD hemp biomass using ME in one or more iterations; and 3) mixtures of ME, DE, and waxes, and incorporation of these mixtures into the one or more of the formulations of category 1 and/or category 2.

In some embodiments, ME and HSO formulations were prepared as follows: 5 wt %, 10 wt %, and 15 wt % HSO samples were prepared by mixing 50 g, 100 g, and 150 g of raw/unrefined HSO into 950 g, 900 g, and 850 g of ME. The solution components were entirely miscible and thus simply mixed, and had high clarity and a beige color. Similarly, samples of 5 wt %, 10 wt %, and 15 wt % HSO were made with petroleum diesel to assess the performance of non-green alternatives to ME.

In some embodiments, CBD hemp biomass extracted samples with ME were prepared as follows: 0.45 kg of CBD hemp biomass (approximately 5 wt % CBD) was mixed with 3.8 L of ME (0.12 kg biomass per L of ME) at room temperature, and was then let to stand for 60 minutes. Time point samples were taken over the course of the 60 minutes, and it was determined via gas chromatography (GC) characterization that CBD content in the ME B extract media had mostly plateaued after 15 minutes. Regardless, the CBD hemp biomass and ME mixture were strained through a 50 micron screen, and the biomass was pressed to remove remaining extract. This extract is defined as 1× (or one iteration of biomass extraction). The resulting media was either mixed (as above in point 2) according to 5 wt % or 15 wt % HSO, or the resulting extract was used for subsequent biomass extraction using the as-described 0.12 kg biomass per L of ME. This resulted in 2× (or two iterations of biomass extractions) extract and 3× (or three iterations of biomass extractions) extract, which describe the number of iterations of ME extractions performed on fresh CBD hemp biomass. The 1×, 2×, and 3× samples were subsequently vacuum filtered to remove fine particulate matter via 1 micron cellulose filter paper. Overall yields of extract were approximately 85-95% by mass. GC quantitative analysis results suggested each iteration (1×, 2×, and 3×) resulted in approximately 1 wt %, 2 wt %, and 3 wt % CBD in extracted samples, respectively. The extracts may not include THC (tetrahydrocannabinol) at a high enough level of quantification, such as <0.10 weight percent.

Mixtures of DE, ME, and wax (e.g., soy wax, beeswax, and/or hemp wax) were prepared as follows: 0.5 wt %, 1.0 wt %, 2.5 wt %, 5.0 wt %, and 10 wt % wax was mixed into ME; 5 g, 10 g, 25 g, and 100 g of wax were dissolved into 995 g, 990 g, 975 g, 950 g, and 900 g of ME. In the case of hemp wax, no heating or considerable mixing was required (irrespective of weight percent of hemp wax), as the system is miscible. Similarly, soy wax was dissolved into ME, but required mild heating (35° C.) and mixing. Likewise, beeswax was dissolved into ME, but required moderate heating (50° C.) and mixing. In all cases of DE and wax, HSO was incorporated, but varied from 5 wt % to 15 wt %.

### Additional Examples

Formulations prepared as described above were visually observed and assessed for miscibility, stability, viscosity, and contact angle (determined visually) on treated wood samples.

For formulations including hemp wax, DE, and ME, no unique characteristics were observed. Over time, the silica particles of DE merely settled out of solution as expected. No unique behavior was observed with hemp wax other than improved water resistance on wood samples (yellow pine, ponderosa pine, fir, and red cedar), which may be attributable to the wax. The control, hemp wax alone, provided similar performance.

For formulations including soy wax and ME, even after heating and forming a miscible solution, upon cooling and over time, the soy wax aggregated and settled out of the ME solution in a matter of minutes. This was the case with and without DE.

For formulations including beeswax, ME, and DE, after heating and forming a miscible solution, upon cooling, there was no observed sedimentation. Instead, this particular formulation maintained stability and suspendability across a wide range of beeswax weight percentages (0.5 wt % to 10 wt %). The DE silica particles also did not sediment out. It was further observed that very small weight percentages (0.1 wt % to 2.5 wt %) of DE in the formulation completely changed the appearance, viscosity, and texture of the resulting composition. In the case of 0.1% DE, the suspension had high clarity and low viscosity, which made spray applications of wood samples possible. It was observed that 1 wt % DE had similarly low viscosity, but reduced clarity. In the case of 2.5 wt % DE, the viscosity dramatically increased, the clarity was opaque, and the texture became that of a gel. In this case, the gel or paste was buffed onto wood samples.

For general comparisons, ME was replaced with petroleum diesel, and the same classes of waxes, heating, and cooling were observed. None of the gel/suspension behavior was observed as was the case for ME as the base solvent, which suggests methyl esters are a driving force behind natural wax bond/adsorption on silica.

Contact angle observations were made across all samples (neat ME, ME with 5 wt % to 15 wt % HSO, ME with various wax types and amounts, ME with HSO, waxes, and DE, etc.) after application to various wood types (yellow pine, ponderosa pine, fir, and red cedar) and drying or “curing” overnight (~12 h). The results indicated: wax of all kinds improved drying time compared to formulations without wax; wax improved water resistance of formulations of all kinds through contact angle assessments; DE and wax provided the fastest dry and cure times, and the drying times were improved by several hours if not more with the introduction of DE into the formulation; DE and wax provided the widest contact angle of any wood sample that was treated; DE and wax provided the best wood finish aesthetically (satin, not oily, and matte); and depending on the formulation, the silica/wax system can be applied to wood through spraying as a low viscosity fluid, or buffing into wood via the high viscosity gel phase.

### Contact Angle Testing on Soy ME Finished Wood Samples

Contact angle testing on a set of prefinished samples was performed. The test specimens were evaluated in accordance with contact angle measurement of substrates or coated surfaces. All specimens were allowed to stabilize in a testing room for 7 days at 70° F. and 50% relative humidity. Testing was performed in the same conditions. Testing included 0.75-inch by 2-inch by 10-inch prefinished specimens that were trimmed for ease of handling during testing. Specimens were treated with one of six treatments: SME 1 was untreated; SME 2 was treated with pure ME (e.g., 100 wt % ME); SME 3 was treated with a formulation comprising 90 wt % ME and 10 wt % HSO; SME 4 was treated with a formulation comprising 85 wt % ME, 10 wt % HSO, and 5 wt % beeswax (BW); SME 5 was treated with a formulation comprising 84.75 wt % ME, 10 wt % HSO, 3.75 wt % BW, and 1.5 wt % DE; and SME 6 was treated with a formulation comprising 83 wt % ME, 10 wt % HSO, 5.0 wt % BW, and 2.0 wt % DE. The samples of each specimen were tests (e.g., SME 1-1, SME 1-2, SME 1-3, SME 2-1, SME 2-2, SME 2-3, etc.).

Each specimen was placed onto the sample stage and a droplet of purified water was applied using a 20 μl pipet. A 10-second video, recording at 10 images per second, was started as the droplet was applied to the surface. Images for the applied water droplet were captured at the initial and final (after 10 seconds) points of the video. Analysis of each image, completed using Ossila Contact Angle software, provided contact angle measurements for both the left and right sides of each water droplet. Data was compiled into a table and average measurements were calculated for each specimen. Results are shown in Table 1.

### Test Results:

TABLE 1
Contact angles for finished wood specimens.

| | | Initial Droplet | | Final Droplet (After | |
|---|---|---|---|---|---|
| | | Measurements Contact | | 10 seconds) Contact | |
| Specimen | Side of | Angle (degrees) | | Angle (degrees) | |
| Label | Droplet | Reading | Average | Reading | Average |
| SME 1-1 | Left | 100.71 | 93.9 | 56.99 | 60.65 |
| | Right | 87.09 | | 64.30 | |
| SME 1-2 | Left | 101.59 | 98.89 | 76.71 | 74.54 |
| | Right | 96.19 | | 72.36 | |
| SME 1-3 | Left | 102.65 | 100.88 | 68.26 | 67.58 |
| | Right | 99.11 | | 66.89 | |
| SME 2-2 | Left | 64.46 | 62.485 | 52.53 | 50.13 |
| | Right | 60.51 | | 47.72 | |
| SME 2-4 | Left | 62.08 | 62.19 | 41.16 | 43.08 |
| | Right | 62.30 | | 45.00 | |
| SME 2-5 | Left | 90.05 | 77.205 | 45.43 | 44.51 |
| | Right | 64.36 | | 43.58 | |
| SME 3-2 | Left | 83.53 | 81.27 | 58.13 | 56.70 |
| | Right | 79.01 | | 55.27 | |
| SME 3-4 | Left | 69.08 | 69.025 | 51.53 | 51.78 |
| | Right | 68.97 | | 52.03 | |
| SME 3-5 | Left | 74.36 | 70.64 | 56.15 | 55.09 |
| | Right | 66.92 | | 54.03 | |
| SME 4-2 | Left | 90.93 | 87.54 | 71.40 | 76.05 |
| | Right | 84.15 | | 80.69 | |
| SME 4-4 | Left | 94.53 | 92.355 | 89.91 | 88.87 |
| | Right | 90.18 | | 87.83 | |
| SME 4-6 | Left | 89.00 | 88.17 | 85.18 | 85.59 |
| | Right | 87.34 | | 85.99 | |
| SME 5-1 | Left | 96.91 | 91.79 | 83.32 | 81.65 |
| | Right | 86.67 | | 79.98 | |
| SME 5-3 | Left | 91.44 | 89.12 | 86.46 | 82.01 |
| | Right | 86.80 | | 77.56 | |
| SME 5-5 | Left | 88.37 | 89.03 | 79.01 | 82.42 |
| | Right | 89.69 | | 85.82 | |
| SME 6-1 | Left | 102.89 | 97.115 | 91.73 | 89.15 |
| | Right | 91.34 | | 86.57 | |
| SME 6-2 | Left | 108.69 | 108.32 | 97.72 | 100.66 |
| | Right | 107.95 | | 103.60 | |
| SME 6-4 | Left | 79.15 | 79.375 | 77.56 | 78.10 |
| | Right | 79.60 | | 78.64 | |

### Discussion

Contact angle measurements can be used to understand the wettability of a surface. In general, if the tested liquid runs across the surface evenly and has no contact angle, then the surface is considered completely wettable. If the contact angle of the liquid droplet at the substrate interface is between 0° and 90°, the surface is considered hydrophilic and wettable. Contact angles between 90° and 180° means the surface is considered non wettable. SME 5 and SME were shown to have improved hydrophobic properties.

### Extended Weather Testing

Extended weathering testing was performed over a 15 month time period. A hemp gel wood preservative according to an embodiment of this disclosure was applied on stained red cedar, green treated pine, untreated yellow pine, untreated ponderosa pine, and untreated maple. One set of wood samples was left untreated, one set of wood samples was treated with the formulation of SME 5 provided above, and the final set of wood samples was treated with SME 6 provided above. The samples that were treated were coated with two coats of HGWP (e.g., SME 5 or SME 6), and allowed to cure outdoors for 24 hours. The wood samples were left outside and exposed to natural weather in Hastings, MN. After 15 months, it was observed that the HGWP performed much better than the untreated samples. For example, the samples treated with SME 5 or SME 6 showed continued water resistance, as well as no mold growth.

The description of certain embodiments included herein is merely exemplary in nature and is in no way intended to limit the scope of the disclosure or its applications or uses. In the included detailed description of embodiments of the present system and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention. Of course, it is to be appreciated that any one of the examples, embodiments, or processes described herein may be combined with one or more other examples, embodiments, and/or processes or be separated and/or performed amongst separate devices or device portions in accordance with the present systems and methods.

As used herein, the term “about” or “substantially” refers to an allowable variance of the term modified by “about” by +10% or +5%. Further, the terms “less than,” “or less,” “greater than”, “more than,” or “or more” include as an endpoint, the value that is modified by the terms “less than,” “or less,” “greater than,” “more than,” or “or more.”

While various aspects and embodiments have been disclosed herein, other aspects and embodiments are contemplated. The various aspects and embodiment disclosed herein are for purposes of illustration and are not intended to be limiting.

1. A composition for treating wood, the composition comprising a methyl ester composition, hemp seed oil (HSO), wax present in an amount of about 10 wt % or less of the composition, and silica present in an amount of about 10 wt % or less of the composition.

2. The composition of claim 1, wherein the wax comprises beeswax.

3. The composition of claim 2, wherein the beeswax is present in an amount of about 3 wt % to about 7 wt % of the composition.

4. The composition of claim 1, wherein the silica comprises diatomaceous earth.

5. The composition of claim 4, wherein the silica is present in an amount of about 1 wt % to about 3 wt % of the composition.

6. The composition of claim 1, wherein the HSO is present in an amount of about 5 wt % to about 15 wt % of the composition.

7. The composition of claim 1, wherein the methyl ester composition comprises a soy methyl ester composition present in an amount of about 75 wt % to about 90 wt % of the composition.

8. The composition of claim 1, wherein the HSO is present in an amount of about 10 wt % of the composition, the wax comprises beeswax present in an amount of about 3.75 wt % of the composition, the silica comprises diatomaceous earth present in an amount of about 1.5 wt % of the composition.

9. The composition of claim 1, wherein the HSO is present in an amount of about 10 wt % of the composition, the wax comprises beeswax present in an amount of about 5 wt % of the composition, the silica comprises diatomaceous earth present in an amount of about 2.0 wt % of the composition.

10. The composition of claim 1, further comprising an extracted cannabidiol present in the composition in an amount of about 0.1 wt % to about 3 wt % of the composition.

11. The composition of claim 1, further comprising one or more terpenes present in an amount of about 0.1 wt % to about 1 wt % of the composition.

12. A method of forming a composition for treating wood, the method comprising:
forming a mixture comprising wax and a methyl ester composition;
mixing hemp seed oil with the mixture comprising the wax and the methyl ester composition; and
mixing silica with at least one of (1) the mixture comprising the wax and the methyl ester composition, (2) the hemp seed oil, and/or (3) the hemp seed oil with the mixture comprising the wax and the methyl ester composition.

13. The method of claim 12, wherein the wax comprises beeswax and forming the mixture comprising the beeswax and the methyl ester composition includes heating the mixture comprising the beeswax and the methyl ester composition to a temperature of about 45° C. to about 55° C. to dissolve the beeswax in the methyl ester composition.

14. The method of claim 13, wherein the beeswax is present in an amount of about 3 wt % to about 7 wt % of the composition.

15. The method of claim 12, wherein the silica comprises diatomaceous earth.

16. The method of claim 14, wherein the silica is present in an amount of about 1 wt % to about 3 wt % of the composition.

17. The method of claim 12, comprising the HSO in an amount of about 5 wt % to about 15 wt % of the composition.

18. The method of claim 12, wherein the methyl ester composition comprises a soy methyl ester composition present in an amount of about 75 wt % to about 90 wt % of the composition.

19. The method of claim 12, wherein the HSO is present in an amount of about 10 wt % of the composition, the wax comprises beeswax present in an amount of about 3.75 wt % of the composition, the silica comprises diatomaceous earth present in an amount of about 1.5 wt % of the composition.

20. The method of claim 12, wherein the HSO is present in an amount of about 10 wt % of the composition, the wax comprises beeswax present in an amount of about 5 wt % of the composition, the silica comprises diatomaceous earth present in an amount of about 2.0 wt % of the composition.

21. The method of claim 12, further comprising mixing one or more terpenes in an amount of about 0.1 wt % to about 1 wt % of the composition into at least one of (1) the mixture comprising the wax and the methyl ester composition, (2) the hemp seed oil, and/or (3) the hemp seed oil and mixed with the mixture comprising the wax and the methyl ester composition.

22. The method of claim 12, further comprising extracting cannabidiol from a cannabidiol hemp biomass with at least a portion of the methyl ester composition before forming the mixture comprising the methyl ester composition and the wax such that the methyl ester composition includes a cannabidiol extract in an amount of about 0.1 wt % to about 3 wt % of the composition.

23. The method of claim 22, extracting the cannabidiol from the cannabidiol hemp biomass with at least the portion of the methyl ester composition includes extracting the cannabidiol from the cannabidiol hemp biomass with at least the portion of the methyl ester composition in multiple iterations.

24. A composition for treating wood, the composition comprising soy methyl ester, hemp seed oil, beeswax, and diatomaceous earth.

25. The composition of claim 24, wherein the composition includes the soy methyl ester present in an amount of about 83 wt % to about 87 wt % of the composition, the hemp seed oil present in an amount of about 8.0 wt % to about 12.0 wt % of the composition, the beeswax present in amount of about 4.0 wt % to about 6.0 wt %, and the diatomaceous earth present in an amount of about 2.0 wt % to about 3.0 wt % of the composition.

26. The composition of claim 24, wherein the composition includes the soy methyl ester present in an amount of about 80 wt % to about 85 wt % of the composition, the hemp seed oil present in an amount of about 8.0 wt % to about 12.0 wt % of the composition, the beeswax present in amount of about 3.0 wt % to about 4.5 wt %, and the diatomaceous earth present in an amount of about 1.0 wt % to about 2.0 wt % of the composition.
